(19) United States
(12) Patent Application Publication
(10) Pub. No.: US 2004/0081225 A1
(43) Pub. Date: Apr. 29, 2004

(54) Plastic enclosed sensor

(76) Inventor: Alan J. Janicek, Morrison, IL (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/065,507

(22) Filed: Oct. 25, 2002

(51) Int. Cl. G01K 7/00

(52) U.S. Cl. 374/185; 374/208

(57) ABSTRACT

A sensor for measuring a temperature of a material in an enclosure is provided. In an exemplary embodiment, the sensor includes a thermistor pill assembly that includes a thermistor pill and conductive leads operatively attached to the thermistor pill, and a sensor body enclosing the thermistor pill assembly. The conductive leads extending through the body. The sensor body is formed from a thermally conductive thermoplastic material.

### BACKGROUND OF INVENTION

This invention relates generally to temperature sensors, and more particularly, to plastic enclosed thermistor type sensors for monitoring temperature in a cooling system.

Thermistors are used in a variety of applications to measure the temperature of materials. For example, thermistors are used to measure the temperature of various components in an internal combustion engine as well as other components in an automobile such as coolant lines in an air conditioning system.

To measure the temperature of the material with the thermistor, it is typically necessary to place the thermistor in intimate contact with the material whose temperature is being measured. To obtain intimate contact between the thermistor and the material, it is frequently necessary to form an aperture in the structure that holds the material. The aperture also typically permits the thermistor to be removably attached to the structure. To prevent escape of the material from the structure, an impervious seal must be formed between the thermistor and the structure as well as between the components in the thermistor.

One technique for preventing the escape of material through the components of the thermistor involves placing a cover over an end of the thermistor that extends into the structure. For example, Metzger et al., U.S. Pat. No. 5,046,857, describes preventing the material whose temperature is being measured from passing through the thermistor by placing a thermistor pill within an outer shell. Temperature of a material outside the outer shell is measured with the thermistor pill positioned in the outer shell. Similarly, Clayton, Jr., U.S. Pat. No. 4,437,084, discloses a thermistor in which a thermistor pill is encapsulated in an outer shell.

A drawback of these encapsulating techniques is that the accuracy of the temperature measurement is limited because the thermistor pill is not in direct contact with the material whose temperature is being measured. As such, temperature changes must be transmitted through the material that encompasses the thermistor pill. Typically these materials are thermally insulating materials.

### SUMMARY OF INVENTION

In one aspect, a sensor for measuring a temperature of a material in an enclosure is provided. The sensor includes a thermistor pill assembly that includes a thermistor pill and conductive leads operatively attached to the thermistor pill, and a sensor body enclosing the thermistor pill assembly. The conductive leads extending through the body. The sensor body is formed from a thermally conductive thermoplastic material.

In another aspect, a temperature sensor is provided that includes a thermistor pill assembly including a thermistor pill and conductive leads operatively attached to the thermistor pill, and a sensor body encapsulating the thermistor pill assembly with the conductive leads extending through the body. The sensor body is formed from a thermally conductive thermoplastic material that includes a thermoplastic crystalline resin.

In another aspect, a method of fabricating a temperature sensor is provided. The temperature sensor includes a thermistor pill assembly and a sensor body. The method includes positioning the thermistor pill assembly in a mold, and introducing a thermally conductive thermoplastic material into the mold to form the sensor body and encapsulate the thermistor pill assembly. The thermistor pill assembly includes a thermistor pill and conductive leads operatively attached to the thermistor pill.

### BRIEF DESCRIPTION OF DRAWINGS

FIG. 1 is a schematic sectional view of a known temperature sensor.

FIG. 2 is a schematic sectional view of a temperature sensor in accordance with an embodiment of the present invention.

### DETAILED DESCRIPTION

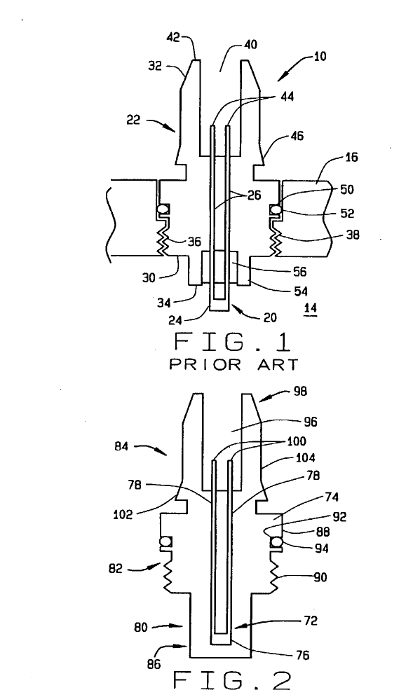

FIG. 1 is a schematic sectional view of a known temperature sensor 10 which is a thermistor type sensor. Temperature sensor 10 is in direct contact with a material 14 in a structure 16 for measuring the temperature of material 14. Temperature sensor 10 prevents material 14 from escaping through or around temperature sensor 10. Temperature sensor 10 is particularly suited for use in structure 16 where material 14 is maintained under a pressure that is greater than ambient pressure. One application where temperature sensor 10 is suited for use is in an automobile air conditioning system.

Temperature sensor 10 includes a thermistor pill assembly 20 and a connector body 22. Thermistor pill assembly 20 has a thermistor pill 24 and a pair of conductive leads 26 operatively attached thereto. Conductive leads 26 are attached to thermistor pill 24 using conventionally known techniques, for example, by soldering conductive leads 26 to thermistor pill 24.

Connector body 22 is molded over at least a portion of conductive leads 26. Connector body 22 generally includes a first portion 30 and a second portion 32, which is opposite first portion 30. Thermistor pill 24 is proximate an end 34 of first portion 30 that is opposite second portion 32. First portion 30 attaches temperature sensor 10 to structure 16 containing material 14. Removably attaching temperature sensor 10 to structure 16 is accomplished with a threaded region 36 on first portion, 30 that is substantially complementary to a threaded region 38 on structure 16.

Second portion 32 operatively connects temperature sensor 10 to a control system (not shown) that monitors and/or records the temperature sensed by temperature sensor 10. A variety of control systems can be used in conjunction with temperature sensor 10. Second portion 32 includes a recess 40 formed into an end 42 of second portion 32 that is opposite first portion 30. Recess 40 provides a socket for attaching the control system (not shown) to temperature sensor 10. Ends 44 of conductive leads 26, which are opposite thermistor pill 24, extend into recess 40. Second portion 32 also has an angled lip 46 extending from an outer surface thereof. Angled lip 46 assists to retain an attachment lead (not shown) from the control system (not shown) in conductive contact with conductive leads 26.

Intermediate first portion 30 and second portion 32, connector body 22 has a channel 50 formed therein. Channel 50 is adapted to receive a resilient O-ring 52. O-ring 52 supplements threaded region 36 to prevent material 14 from escaping by passing between temperature sensor 10 and structure 16.

End 34 of first portion 30 includes a recess 54 formed therein proximate where conductive leads 26 extend through end 34. Recess 54 is filled with an adhesive sealant 56 that forms a strong bond with both conductive leads 26 and connector body 22. Adhesive sealant 56 thereby prevents material 14 from escaping by passing between conductive leads 26 and connector body 22. Adhesive sealant 56 is an encapsulating epoxy, for example EP729S, commercially available from Thermoset Plastics, Inc. (Indianapolis, Ind.).

Materials used for fabricating connector body 22 resist degradation by material 14. For example, when temperature sensor 10 is used in an air conditioning system, connector body 22 is fabricated to resist degradation by the refrigerant fluid as well as by any lubricants used therewith. Suitable materials for fabricating connector body 14 include polyetherimide, for example, ULTEM commercially available from General Electric Company, and polybutylene terephalate, for example, VALOX, commercially available from General Electric Company. These materials used for fabricating connector body 14 are thermally insulating materials.

FIG. 2 is a schematic sectional view of a temperature sensor 70 in accordance with an embodiment of the present invention. In an exemplary embodiment, temperature sensor 70 is a thermistor type temperature sensor and includes a thermistor pill assembly 72 enclosed in a sensor body 74. Thermistor pill assembly 72 includes a thermistor pill 76 and a pair of conductive leads 78 operatively attached to thermistor pill 76. Conductive leads 78 are attached to thermistor pill 76 using conventionally known techniques. One such suitable technique for attaching conductive leads 78 to thermistor pill 76 involves soldering conductive leads 78 to thermistor pill 76.

Sensor body 74 is molded over at least a portion of thermistor pill assembly 72. Sensor body 74 includes a first portion 80, a second portion 82, and a third portion 84 with second portion located between first and third portions 82 and 84. Thermistor pill 76 is located at an end portion 86 of first portion 80. An outer surface 88 of second portion 82 of sensor body 74 includes a plurality of threads 90 extending circumferentially around sensor body 74. Outer surface 88 also includes a circumferential groove 92 adjacent threads 90. Groove 90 is sized to receive an O-ring 94.

Third portion 84 operatively connectes temperature sensor 70 to a control system (not shown) that monitors and/or records the temperature sensed by temperature sensor 70. A variety of control systems can be used in conjunction with temperature sensor 70. Third portion 84 includes a recess or connection cavity 96 formed into an end 98 of second portion 96 that is opposite second portion 82. Recess 96 provides a socket for attaching the control system (not shown) to temperature sensor 70. Ends 100 of conductive leads 78, which are opposite thermistor pill 76, extend into recess 96. Third portion 84 also has an angled lip 102 extending from an outer surface 104 thereof. Angled lip 102 retains an attachment lead (not shown) from the control system (not shown) in conductive contact with conductive leads 78.

Sensor body 74 is molded from a thermally conductive thermoplastic material that also has sufficient mechanical properties to permit temperature sensor 70 to be threaded into a temperature sensing port of, for example, an air conditioning system. Suitable thermally conductive thermoplastic materials for fabricating sensor body 74 include a thermoplastic crystalline resin, for example, polyphenylene sulfide and polyetheretherketone. These thermally conductive thermoplastic materials can also include thermally conductive additives, and fillers, for example, glass fibers. Thermally conductive thermoplastic materials suitable for fabricating sensor body 74 are commercially available from LNP Plastics under the trademark KONDUIT.

Temperature sensor 70 can be fabricating using an insert molding technique. First thermistor pill assembly 72 is positioned in a mold as an insert and then a thermally conductive thermoplastic material is introduced into the mold to encapsulate thermistor pill 76 and conductive leads 78. Thermistor pill assembly 72 is in intimate contact with the thermally conductive material to provide for accurate temperature readings within the desired response times. To accomplish the desired response times the thickness of thermally conductive thermoplastic material encapsulating thermistor pill 76 in first portion 80 of sensor body 74 is less than the thickness of thermally conductive thermoplastic material encapsulating conductive leads 78 in second portion 82 of sensor body 74. The greater thickness of the thermally conductive thermoplastic material of threaded second portion 82 provides for increased strength and the desired mechanical properties of sensor body 74. Therefore, a diameter of first portion 80 is less than a diameter of second portion 82.

While the invention has been described in terms of various specific embodiments, those skilled in the art will recognize that the invention can be practiced with modification within the spirit and scope of the claims.

1. A sensor for measuring a temperature of a material in an enclosure, said sensor comprising:
a thermistor pill assembly comprising a thermistor pill and conductive leads operatively attached to said thermistor pill; and
a sensor body enclosing said thermistor pill assembly, said conductive leads extending through said body, said sensor body comprising a thermally conductive thermoplastic material.

2. A sensor in accordance with claim 1 wherein said thermally conductive thermoplastic material comprises a thermoplastic crystalline resin.

3. A sensor in accordance with claim 3 wherein said thermally conductive thermoplastic material comprises at least one of polyphenylene sulfide and polyetheretherketone.

4. A sensor in accordance with claim 1 wherein said sensor body further comprises an outer surface, said outer surface comprising circumferential threads.

5. A sensor in accordance with claim 4 wherein said sensor body outer surface further comprises a circumferential groove.

6. A sensor in accordance with claim 5 further comprising an O-ring seal positioned in said circumferential groove.

7. A sensor in accordance with claim 1 wherein said thermistor pill assembly is encapsulated by said thermally conductive thermoplastic material of said sensor body, said thermistor pill assembly in intimate contact with said thermally conductive thermoplastic material.

8. A sensor in accordance with claim 1 wherein said sensor body comprises a first portion and a second portion, said thermistor pill located in said first portion of said sensor body, and said conductive leads extending through said second portion of said sensor body, wherein a diameter of said first portion of said sensor body is less than a diameter of said second portion of said sensor body.

9. A sensor in accordance with claim 8 wherein said second portion comprises a connection cavity, said conductive leads extending into said connection cavity.

10. A temperature sensor comprising:
a thermistor pill assembly comprising a thermistor pill and conductive leads operatively attached to said thermistor pill; and
a sensor body encapsulating said thermistor pill assembly, said conductive leads extending through said body, said sensor body comprising a thermally conductive thermoplastic material that comprises a thermoplastic crystalline resin.

11. A sensor in accordance with claim 10 wherein said thermally conductive thermoplastic crystalline resin comprises at least one of polyphenylene sulfide and polyetheretherketone.

12. A sensor in accordance with claim 10 wherein said sensor body further comprises an outer surface, said outer surface comprising circumferential threads and a circumferential groove.

13. A sensor in accordance with claim 12 further comprising an O-ring seal positioned in said circumferential groove.

14. A sensor in accordance with claim 10 wherein said thermistor pill assembly is in intimate contact with said thermally conductive thermoplastic material.

15. A sensor in accordance with claim 10 wherein said sensor body comprises a first portion and a second portion, said thermistor pill located in said first portion of said sensor body, and said conductive leads extending through said second portion of said sensor body, wherein a diameter of said first portion of said sensor body is less than a diameter of said second portion of said sensor body.

16. A sensor in accordance with claim 15 wherein said second portion comprises a connection cavity, said conductive leads extending into said connection cavity.

17. A method of fabricating a temperature sensor, the temperature sensor comprising a thermistor pill assembly and a sensor body said method comprising:
positioning the thermistor pill assembly in a mold, the thermistor pill assembly comprising a thermistor pill and conductive leads operatively attached to the thermistor pill; and
introducing a thermally conductive thermoplastic material into the mold to form the sensor body and encapsulate the thermistor pill assembly.

18. A method in accordance with claim 17 wherein the thermally conductive;
thermoplastic material comprises a thermoplastic crystalline resin.

19. A method in accordance with claim 18 wherein the thermally conductive thermoplastic material comprises at least one of polyphenylene sulfide and polyetheretherketone.

20. A method in accordance with claim 17 wherein the sensor body comprises a first portion and a second portion, the thermistor pill located in the first portion of the sensor body, and the conductive leads extending through the second portion of the sensor body, wherein a diameter of the first portion of the sensor body is less than a diameter of the second portion of the sensor body.
